(19) United States
(12) Patent Application Publication
(10) Pub. No.: US 2014/0258876 A1
(43) Pub. Date: Sep. 11, 2014

(54) ELECTRONIC APPARATUS THAT DISPLAYS MESSAGE SCREEN

(71) Applicant: Kyocera Document Solutions Inc., Osaka (JP)

(72) Inventors: Daisuke Yoshida, Osaka (JP); Toyoaki Oku, Osaka (JP); Koki Nakajima, Osaka (JP); Takeshi Nakamura, Osaka (JP); Yoshihiko Arai, Osaka (JP); Atsushi Matsumoto, Osaka (JP)

(73) Assignee: Kyocera Document Solutions Inc., Osaka (JP)

(21) Appl. No.: 14/192,143

(22) Filed: Feb. 27, 2014

(30) Foreign Application Priority Data
Mar. 8, 2013 (JP) 2013-047233

(51) Int. Cl. G06F 3/0484

(52) U.S. Cl. CPC G06F 3/0484
USPC 715/738

(57) ABSTRACT

An electronic apparatus includes: an operation panel configured to display a screen and receive an operation performed by a user; an agent unit configured to, upon receipt of message data from a remote maintenance server on a maintenance service provider side, provide an instruction to display a message screen based on the message data; and a display control unit configured to control the display of a screen on the operation panel and configured to, when the instruction to display the message screen is received while an operation screen is being displayed, display the message screen on the operation panel upon detection of an end of an operation of the operation panel performed by the user.

### REFERENCE TO RELATED APPLICATIONS

This application is based upon and claims the benefit of priority from the corresponding Japanese Patent Application No. 2013-047233, filed in the Japan Patent Office on Mar. 8, 2013, the entire contents of which are incorporated herein by reference.

### FIELD

The present disclosure relates to an electronic apparatus that displays a message screen.

### BACKGROUND

In typical electronic apparatus management systems, a management apparatus notifies an image forming apparatus of the date and time of scheduled maintenance, and the image forming apparatus displays this date and time on an operation panel.

In typical electronic apparatus management systems, a message indicating the date and time of the scheduled maintenance may be suddenly displayed on an operation panel that is being operated by a user. In this case, the user's operation is interrupted, and when the user deletes the message in a hurry without confirming the content of the message, there is no way to confirm the content later.

### SUMMARY

An electronic apparatus according to an embodiment of the present disclosure includes: an operation panel, an agent unit, and a display control unit. The operation panel is configured to display a screen and receive an operation performed by a user. The agent unit is configured to, upon receipt of message data from a remote maintenance server on a maintenance service provider side, provide an instruction to display a message screen based on the message data. The display control unit is configured to control the display of a screen on the operation panel and, upon receipt of the instruction to display the message screen from the agent unit while an operation screen is being displayed, display the message screen on the operation panel when an end of an operation of the operation panel performed by the user is detected.

A non-volatile computer-readable recording medium according to an embodiment of the present disclosure stores a message display control program that is executable by a computer in an electronic apparatus. The message display control program includes first to third program codes. The first program code causes the computer to display a screen and receive an operation performed by a user. The second program code causes the computer to, upon receipt of message data from a remote maintenance server on a maintenance service provider side, provide an instruction to display a message screen based on the message data. The third program code causes the computer to control the display of a screen on the operation panel and, upon receipt of the instruction to display a message screen provided by the second program code while an operation screen is being displayed, display the message screen on the operation panel when an end of an operation of the operation panel performed by the user is detected.

A message display control method according to an embodiment of the present disclosure includes: (i) displaying a screen and receiving an operation performed by a user, using an operation panel; (ii) providing, upon receipt of message data from a remote maintenance server on a maintenance service provider side, an instruction to display a message screen based on the message data, using an agent unit; and (iii) controlling the display of a screen of the operation panel and displaying, upon receipt of the instruction to display a message screen from the agent unit while an operation screen is being displayed, the message screen on the operation panel when an end of an operation of the operation panel performed by the user is detected, using a display control unit.

Additional features and advantages are described herein, and will be apparent from the following detailed description and the figures.

### BRIEF DESCRIPTION OF THE DRAWINGS

All drawings are intended to illustrate some aspects and examples of the present disclosure. The drawings described are only schematic and are non-limiting, and are not necessarily drawn to scale.

FIG. 1 illustrates a configuration of a message management system according to an embodiment of the present disclosure;

FIG. 2 illustrates an example of the operation panel of the image forming apparatus illustrated in FIG. 1;

FIG. 3 illustrates an example operation screen displayed on the operation panel of the image forming apparatus illustrated in FIG. 1;

FIG. 4 illustrates an example of a digital note displayed on the operation panel of the image forming apparatus illustrated in FIG. 1;

FIG. 5 illustrates the steps of message management processing in the message management system illustrated in FIG. 1;

FIG. 6 illustrates the steps of controlling the display of a digital note performed in the fifth step illustrated in FIG. 5; and

FIG. 7 illustrates an example of a notification image displayed in a notification area of the operation screen illustrated in FIG. 3.

### DETAILED DESCRIPTION

Various embodiments are described below with reference to the figures. It should be understood, however, that numerous variations from the depicted arrangements and functions are possible while remaining within the scope and spirit of the claims. For instance, one or more elements may be added, removed, combined, distributed, substituted, re-positioned, re-ordered, and/or otherwise changed. Further, where this description refers to one or more functions being implemented on and/or by one or more devices, one or more machines, and/or one or more networks, it should be understood that one or more of such entities could carry out one or more of such functions by themselves or in cooperation, and may do so by application of any suitable combination of hardware, firmware, and/or software. For instance, one or more processors may execute one or more sets of programming instructions as at least part of carrying out one or more of the functions described herein.

Hereinafter, embodiments of the present disclosure will be described with reference to the drawings.

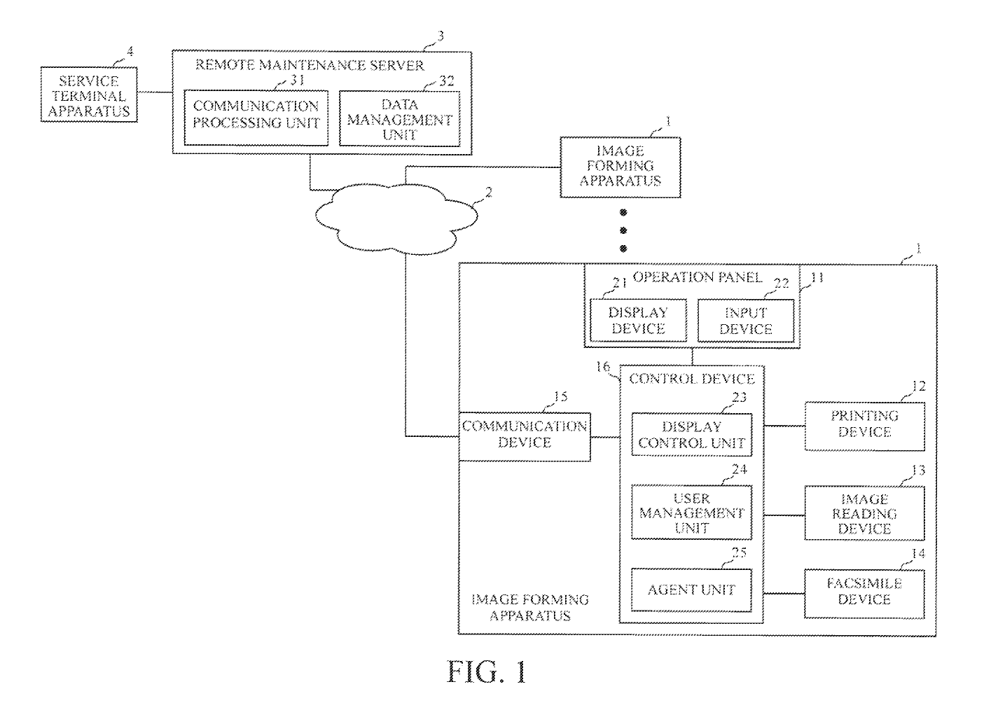

FIG. 1 illustrates a configuration of a message management system according to an embodiment of the present disclosure.

In the system illustrated in FIG. 1, image forming apparatuses 1 are installed on a customer side of the maintenance service system and are connected to a network 2. A remote maintenance server 3 installed on a maintenance service provider side of the system transmits message data, such as a maintenance message, to one of the image forming apparatuses 1 through the network 2. The image forming apparatus 1 displays the transmitted message.

Note that this message is called a “digital note”, hereinafter. The digital note may include advertisement information other than information regarding maintenance. The digital note includes text, images, and the like.

Message data is generated in a service terminal apparatus 4 on the maintenance service provider side and registered in the remote maintenance server 3 by the service terminal apparatus 4. The message data is transmitted from the remote maintenance server 3 and received by the image forming apparatus 1.

In other words, a service person of the maintenance service provider, through operation of the service terminal apparatus 4, specifies the image forming apparatus 1 in which a digital note is to be displayed and inputs the content of the digital note. The service terminal apparatus 4 can be a personal computer. The service terminal apparatus 4 generates the message data of the digital note and registers the message data in the remote maintenance server 3, based on operations performed by the service person.

The image forming apparatus 1 that is an electronic apparatus including an operation panel 11 can be a multifunction apparatus.

The image forming apparatus 1 can include a printing device 12, an image reading device 13, a facsimile device 14, a communication device 15, and a control device 16, in addition to the operation panel 11.

The operation panel 11 is arranged on the upper surface of the image forming apparatus 1. The operation panel 11 includes a display device 21 for displaying screens for a user and an input device 22 for receiving operations performed by the user. The display device 21 is, for example, a liquid crystal display. The input device 22 includes, for example, hard keys and a touch panel that includes soft keys together with the display device 21.

The printing device 12 is an internal device that prints an image based on image data using, for example, an electronic photography method.

The image reading device 13 is an internal device that optically reads the document image of a document, and generates image data of the document image.

The facsimile device 14 is an internal device that transmits a facsimile signal of the document image and receives a facsimile signal and generates the image data of a document from the facsimile signal.

The communication device 15 is connected to the network 2. The communication device 15 is an internal device that performs data communication with other devices (for example, the remote maintenance server 3) connected to the network 2. A network interface or a modem, for example, is used as the communication device 15.

The control device 16 that includes a computer loads a message display control program from a storage device or a recording medium, not illustrated, and executes the message display control program using the computer, whereby realizing various processing units. The control device 16 realizes a display control unit 23, a user management unit 24, and an agent unit 25.

The display control unit 23 controls the display of screens on the display device 21 of the operation panel 11.

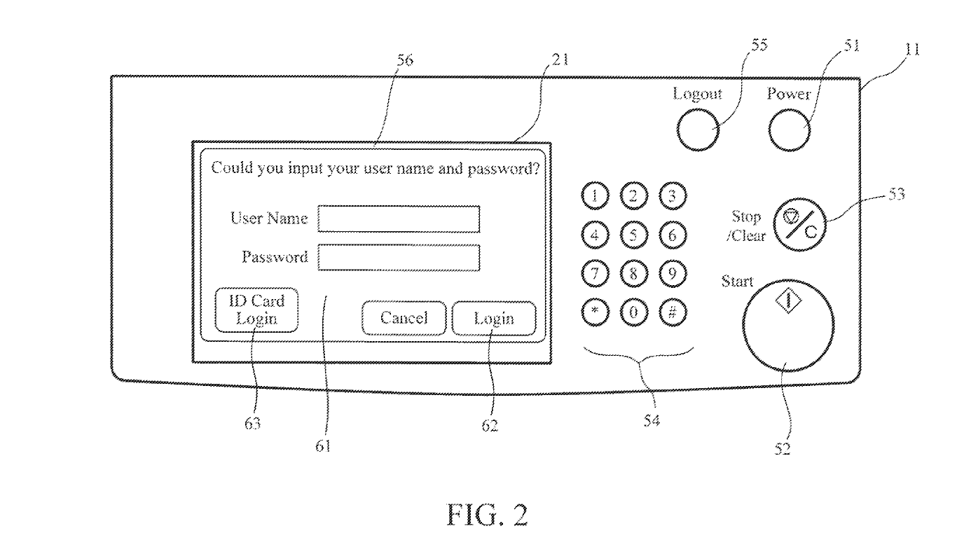

FIG. 2 illustrates an example of the operation panel 11 of the image forming apparatus 1 illustrated in FIG. 1. The operation panel 11 illustrated in FIG. 2 includes hard keys 51 to 55 and a touch panel 56, provided as the input device 22. Hard key 51 is a power key, hard key 52 is a start key, hard key 53 is a stop/clear key, hard keys 54 are ten keys, and hard key 55 is a log-out key. The touch panel 56 is arranged on the display surface of the display device 21.

Referring to FIG. 2, a log-in screen 61 is displayed on the operation panel 11 of the display device 21. On the log-in screen 61, input fields for inputting a user ID (user name) and a password, a log-in key 62 for user authentication and for logging in be executed and terminating the display of the log-in screen 61, an ID card log-in key 63 for logging in with an ID card, and the like are displayed. Note that, for example, a user ID and a password are inputted using the ten keys (hard keys 54).

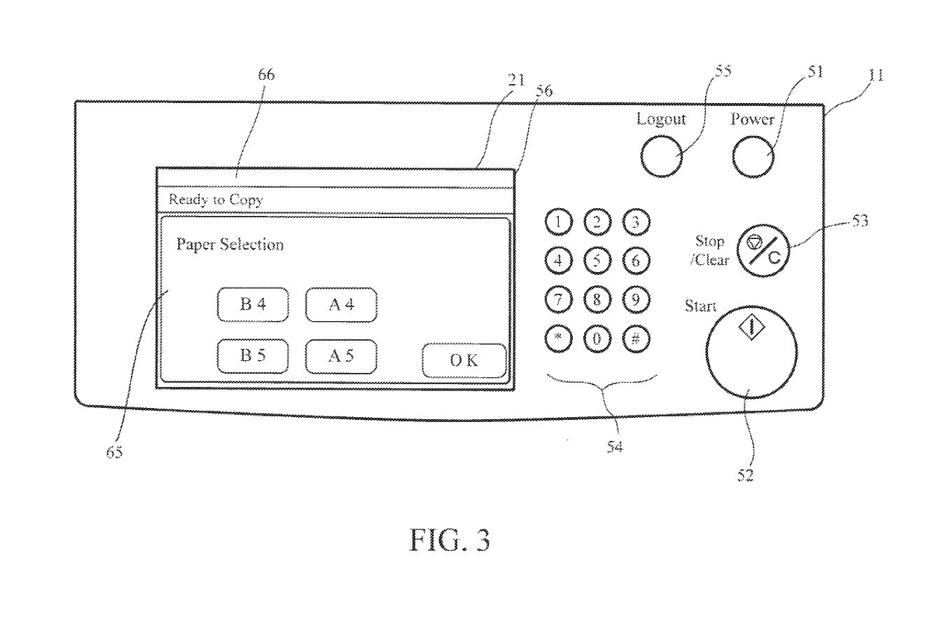

FIG. 3 illustrates an example operation screen displayed on the operation panel 11 of the image forming apparatus 1 illustrated in FIG. 1.

Referring to FIG. 3, an operation screen 65 is displayed on the display device 21 of the operation panel 11. Note that the operation screen is a screen allowing a user to input settings at the time of using a certain function of the image forming apparatus 1 and to input instructions for executing the processing for that function. The operation screen illustrated in FIG. 3 is an operation screen for a copy function. The operation screen 65 includes a notification area 66. In the notification area 66, notification images corresponding to various events are displayed. A user, through the notification image, can be notified of the occurrence of an event corresponding to the notification image.

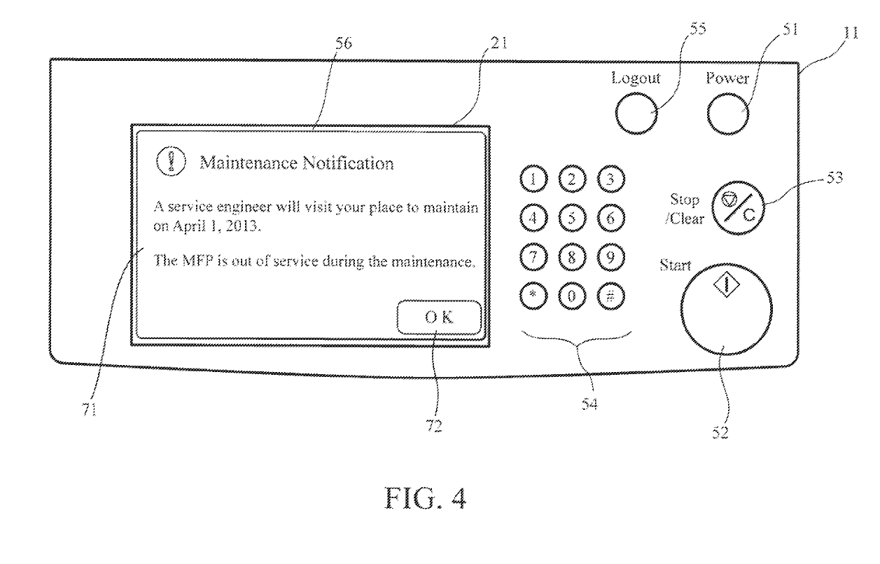

FIG. 4 illustrates an example of a digital note displayed on the operation panel 11 of the image forming apparatus 1 illustrated in FIG. 1.

Referring to FIG. 4, the display device 21 of the operation panel 11 displays a message screen 71. On the message screen 71, a message (here, a text message) as the digital note and an OK key 72 for terminating the display of the message screen 71 are displayed.

Referring back to FIG. 1, when the display control unit 23 receives an instruction to display the message screen 71 from the agent unit 25 while the operation screen 65 is being displayed, the display control unit 23 does not immediately display the message screen 71 on the operation panel 11, and displays the message screen 71 on the operation panel 11 after the termination of an operation of the operation panel performed by a user has been detected.

In the embodiment, when the display control unit 23 receives an instruction to display the message screen 71 from the agent unit 25 while the operation screen 65 subsequent to logging in performed by a user is being displayed, the display control unit 23 does not immediately display the message screen 71 on the operation panel 11, and displays the message screen 71 on the operation panel 11 after the user management unit 24 has detected a log-out operation.

In the embodiment, when the display control unit 23 receives an instruction to display the message screen 71 from the agent unit 25 while the operation screen 65 is being displayed, the display control unit 23 immediately displays a notification image indicating the reception of message data in the notification area 66 within the operation screen 65, on the operation panel 11.

Further, in the embodiment, if the display control unit 23 detects a specific operation (for example, pressing of a notification image functioning as the soft key) while the notification image is being displayed, the display control unit 23 displays the message screen 71 at the front on the operation panel 11 in such a manner that the message screen 71 is superimposed on the operation screen 65. Then, if the display control unit 23 detects a display termination operation (for example, pressing of the OK key 72) performed on the operation panel 11 while the message screen 71 is being displayed, the display control unit 23 terminates the display of the message screen 71 and displays the operation screen 65 at the front on the operation panel 11.

The user management unit 24 detects a log-in operation and a log-out operation performed on the operation panel 11 by a user, and determines whether or not the user is permitted to log in based on the user information (for example, user identification information and user rights information) of registered users stored in a storage device (not illustrated). The user identification information is, for example, a user ID or a user ID and password. The user rights information is information about the types of user, such as a management user and a general user.

The agent unit 25, when message data is received from the remote maintenance server 3 on the maintenance service provider side, instructs the display control unit 23 to display a message screen based on the message data. Further, when the operation panel 11 receives a display termination operation while the message screen is being displayed on the operation panel 11, the agent unit 25 generates reading confirmation data for indicating that a user has read the message screen, and transmits the reading confirmation data to the remote maintenance server 3.

The agent unit 25 transmits, to the remote maintenance server 3, the reading confirmation data including the user identification information of a user who has terminated the display of the message screen of a digital note.

Note that, in the embodiment, the agent unit 25 transmits reading confirmation data including the rights information together with the user identification information of the user, to the remote maintenance server 3.

Further, the remote maintenance server 3 includes a communication processing unit 31 and a data management unit 32. The communication processing unit 31 receives message data of a digital note from the service terminal apparatus 4, and transmits the message data to the image forming apparatus 1 corresponding to the destination address of the message data. The data management unit 32 receives the reading confirmation data from the image forming apparatus 1, and transmits the reading confirmation data to the service terminal apparatus 4 in response to a request from the service terminal apparatus 4.

Message management processing in the message management system according to an embodiment will now be described.

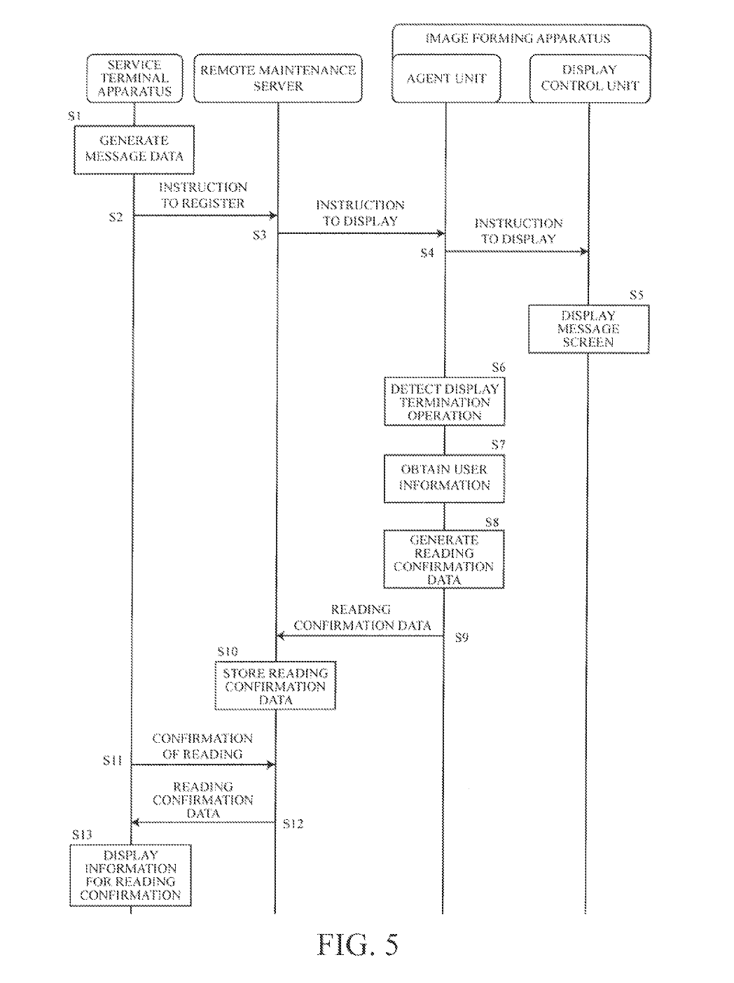

FIG. 5 illustrates the steps of message management processing in the message management system illustrated in FIG. 1.

First, in a service center or the like, a service person, through operation of the service terminal apparatus 4, specifies the image forming apparatus 1 where a digital note is to be displayed and inputs the content of the digital note. The service terminal apparatus 4 generates message data of the digital note based on the operations performed by the service person (step S1) and transmits the message data and the identification information of the image forming apparatus 1, together with an instruction to register the digital note, to the remote maintenance server 3 (step S2).

In the remote maintenance server 3, when the communication processing unit 31 receives the message data and the identification information of the image forming apparatus 1, together with the instruction to register the digital note, the data management unit 32 temporarily stores these. Then, the communication processing unit 31 transmits the message data together with the instruction to register the digital note to the specified image forming apparatus 1 (step S3). Note that the message data or the instruction to display the digital note includes a digital note ID.

In the image forming apparatus 1, when the communication device 15 receives the instruction to display the digital note and the message data, the agent unit 25 instructs the display control unit 23 to display a message screen based on the message data (step S4).

The display control unit 23 controls the instruction to display the message screen 71 (step S5). The details of the display control in step S5 will be described later.

The message screen 71 is displayed on the operation panel 11 at certain timing based on the display control in step S5.

Then, if a user who has logged in performs a display termination operation (for example, pressing of the OK key 72 illustrated in FIG. 3) on the message screen 71, the agent unit 25 detects the display termination operation performed on the operation panel 11 (step S6), makes the display control unit 23 terminate displaying the message screen 71 of the digital note. The display control unit 23 terminates displaying the message screen 71 of the digital note.

When displaying of the message screen 71 is terminated, the agent unit 25 obtains user information such as a user ID and rights information from the user management unit 24 (step S7), and generates reading confirmation data including the digital note ID and the user information (step S8). The agent unit 25 transmits the generated reading confirmation data to the remote maintenance server 3 (step S9).

In the remote maintenance server 3, the communication processing unit 31 receives the reading confirmation data and the data management unit 32 stores the received reading confirmation data (step S10). For example, the data management unit 32 stores the reading confirmation data regarding the digital note in association with the digital note.

After that, the service person can read the reading confirmation data regarding the digital note through operation of the service terminal apparatus 4. The service terminal apparatus 4 transmits a request for confirmation of reading regarding the digital note issued by the service person to the remote maintenance server 3, based on the operation performed by the service person (step S11). The remote maintenance server 3 transmits the reading confirmation data regarding the digital note specified in the reading confirmation request to the service terminal apparatus 4 (step S12). The service terminal apparatus 4, upon receipt of the reading confirmation data, displays the digital note and information about the user who has read the digital note (step S13). As a result, the service person is capable of confirming that the digital note has been read and who has read the digital note.

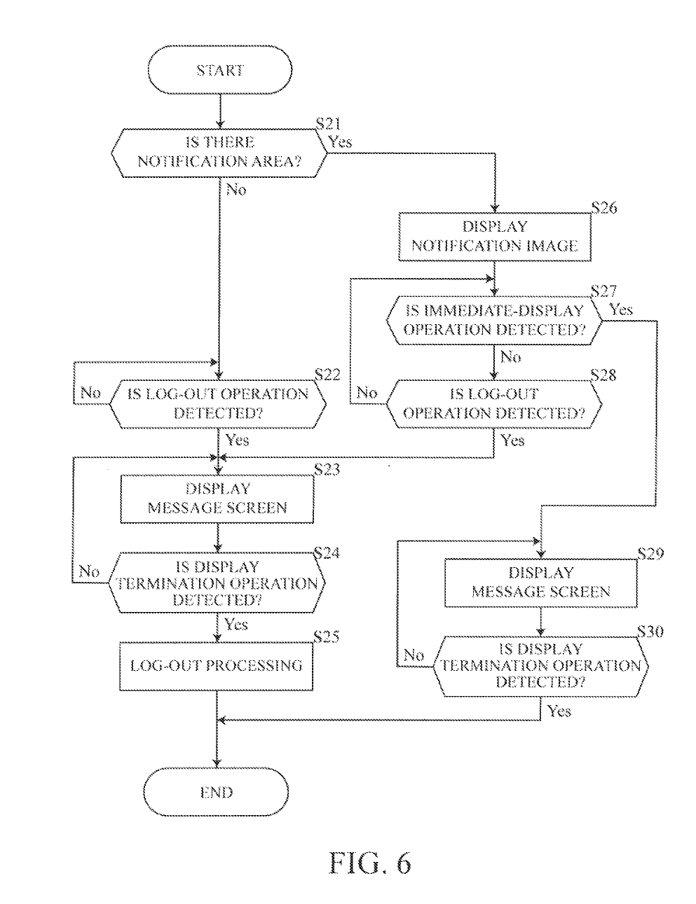

FIG. 6 illustrates the steps of controlling the display of the digital note performed in step S5 illustrated in FIG. 5.

The display control unit 23, upon receipt of an instruction to display the message screen from the agent unit 25 while a user is in a logged-in state, first determines whether or not there is the notification area 66 in the operation screen 65 currently being operated (step S21).

If the notification area 66 does not exist in the currently displayed operation screen 65, the display control unit 23 waits until a log-out operation (for example, pressing the log-out key) performed on the operation panel 11 by a user is detected (step S22), and if the log-out operation is detected, displays the message screen 71 (i.e., digital note) to be displayed based on the instruction, on the operation panel 11 (step S23).

Then, if a display termination operation (for example, pressing of the OK key 72) performed on the operation panel 11 is detected while the message screen 71 is being displayed (step S24), the display control unit 23 starts the log-out process, terminates the display of the message screen 71 and the operation screen 65, and displays the log-in screen 61 on the operation panel 11 (step S25). Note that, at this time, the agent unit 25 obtains the user information regarding the user in a logged-in state from the user management unit 24 before the log-out process is finished.

On the other hand, if it is determined in step S21 that there is the notification area 66 in the operation screen 65, the display control unit 23 immediately displays a notification image indicating that message data (i.e., digital note) has been received in the notification area 66 (step S26).

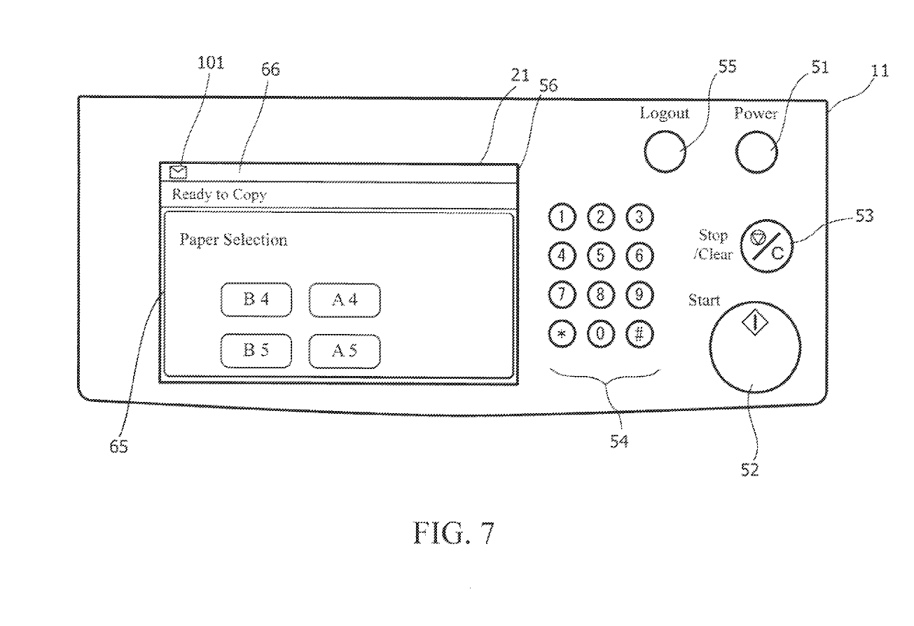

FIG. 7 illustrates an example of the notification image displayed in the notification area 66 of the operation screen 65 illustrated in FIG. 3. In the example illustrated in FIG. 7, a notification image 101 is displayed.

Then, the display control unit 23 waits until an immediate-display operation (for example, pressing of the notification image 101) or a log-out operation is performed (steps S27, S28).

The display control unit 23, upon detection of a log-out operation (step S28), displays the message screen 71 to be displayed based on the instruction, on the operation panel 11, as described above (step S23). Then, the display control unit 23, upon detection of a display termination operation (step S24), terminates the display of the message screen 71 and the operation screen 65 and displays the log-in screen 61 on the operation panel 11 (step S25).

On the other hand, the display control unit 23, upon detection of an immediate-display operation (step S27), displays the message screen 71 to be displayed based on the instruction, on the operation panel 11, in such a manner that the message screen 71 is superimposed on the operation screen 65 (step S29). Then the display control unit 23, upon detection of a display termination operation (step S30), terminates the display of the message screen 71, and displays the original operation screen 65 at the front on the operation panel 11 (step S30). Note that when the display control unit 23 displayed the message screen 71 upon detection of the immediate-display operation, the display control unit 23 does not display the message screen 71 if a log-out operation is detected after that.

In this manner, the display control unit 23 controls the display of a message screen (i.e., digital note). Note that the display termination operation performed in step S24 or S30 in FIG. 6, is the display termination operation performed in step S6 illustrated in FIG. 5.

As described above, according to the embodiment, when the display control unit 23 receives an instruction to display the message screen 71 from the agent unit 25 while the operation screen 65 is being displayed, the display control unit 23 does not immediately display the message screen 71 on the operation panel 11, and displays the message screen 71 on the operation panel 11 after it has been detected that an operation of the operation panel 11 performed by a user has been finished.

As a result, when a digital note transmitted from a remote maintenance service provider side is displayed in the image forming apparatus 1, the digital note is displayed in such a manner as not to disturb the operation of a user who is using the image forming apparatus 1.

Note that the embodiments are examples of the present disclosure. The present disclosure is not limited to these embodiments, and various modifications and changes are possible within the scope of the present disclosure.

For example, in the embodiment, by setting target-user attribute information in message data (i.e., digital note), display control may be performed based on the value of the target user attribute.

For example, in the case of message data having a target-user attribute corresponding to a management user, when the message data is received while no users are in a logged-in state, the display control unit 23 does not immediately display a message screen and displays a message screen based on the message data when a user performed a log-out operation or an immediate-display operation. When message data is received while a management user is in a logged-in state, the display control unit 23 displays a message screen based on the message data when the management user performed a log-out operation or an immediate-display operation. Note that when message data is received while a general user is in a logged-in state, the display control unit 23 does not display a message screen based on the message data.

In the case of message data having a target-user attribute corresponding to a general user, when message data is received while no users are in a logged-in state, the display control unit 23 immediately displays a message screen based on the messaged data. When message data is received while a user is in a logged-in state, the display control unit 23 displays the message screen based on the message data when the user in a logged-in state performed a log-out operation or an immediate-display operation.

In the embodiment, the log-out process may be started at the time when a log-out operation is detected or may be started at the time when a display termination operation performed on a message screen displayed after the detection of a log-out operation has been detected.

The present disclosure is applicable to electronic apparatuses having an operation panel.

It should be understood that various changes and modifications to the presently embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. An electronic apparatus comprising:
an operation panel configured to display a screen and receive an operation performed by a user;
an agent unit configured to, upon receipt of message data from a remote maintenance server on a maintenance service provider side, provide an instruction to display a message screen based on the message data; and
a display control unit configured to control the display of a screen on the operation panel and, upon receipt of the instruction to display the message screen from the agent unit while an operation screen is being displayed, display the message screen on the operation panel when an end of an operation of the operation panel performed by the user is detected.

2. The electronic apparatus according to claim 1, comprising:
a user management unit configured to detect a log-in operation and a log-out operation performed on the operation panel by the user, and
the display control unit is configured to, upon receipt of the instruction to display the message screen from the agent unit while the operation screen subsequent to the log-in operation is being displayed, display the message screen on the operation panel when the user management unit detects the log-out operation.

3. The electronic apparatus according to claim 1,
wherein the display control unit is configured to, upon receipt of the instruction to display the message screen from the agent unit while the operation screen is being displayed, immediately display, if there is a notification area in the operation screen, a notification image indicating reception of the message data in the notification area on the operation panel.

4. The electronic apparatus according to claim 3,
wherein the display control unit is configured to, upon detection of a specific operation on the operation panel while the notification image is being displayed, display the message screen in such a manner that the message screen is superimposed on the operation screen.

5. The electronic apparatus according to claim 4,
wherein the display control unit is configured to, upon detection of a display termination operation on the operation panel while the message screen is being displayed, terminate the display of the message screen and display the operation screen on the operation panel.

6. The electronic apparatus according to claim 1,
wherein the message data includes target-user attribute information, and
the display control unit is configured to, upon receipt of the instruction to display the message screen from the agent unit while the operation screen is not being displayed, immediately display the message screen when the target-user attribute corresponding to the target-user attribute information is a general user, and when the target-user attribute corresponding to the target-user attribute information is a management user, display the message screen upon detection of an end of an operation of the operation panel performed by the management user.

7. A non-volatile computer-readable recording medium storing a message display control program that is executable by a computer in an electronic apparatus, the message display control program comprising:
a first program code causing the computer to display a screen and receive an operation performed by a user;
a second program code causing the computer to, upon receipt of message data from a remote maintenance server on a maintenance service provider side, provide an instruction to display a message screen based on the message data; and
a third program code causing the computer to control the display of a screen on the operation panel and, upon receipt of the instruction to display a message screen provided by the second program code while an operation screen is being displayed, display the message screen on the operation panel when an end of an operation of the operation panel performed by the user is detected.

8. The non-volatile computer-readable recording medium according to claim 7, comprising:
a fourth program code causing the computer to detect a log-in operation and a log-out operation performed on the operation panel by the user, and
the third program code causes the computer to, upon receipt of the instruction to display the message screen provided by the second program code while the operation screen subsequent to the log-in operation is being displayed, display the message screen on the operation panel when the fourth program code detects the log-out operation.

9. The non-volatile computer-readable recording medium according to claim 7,
wherein the third program code causes the computer to, upon receipt of the instruction to display the message screen provided by the second program code while the operation screen is being displayed, immediately display, if there is a notification area in the operation screen, a notification image indicating reception of the message data in the notification area on the operation panel.

10. The non-volatile computer-readable recording medium according to claim 9,
wherein the third program code causes the computer to, upon detection of a specific operation on the operation panel while the notification image is being displayed, display the message screen in such a manner that the message screen is superimposed on the operation screen.

11. The non-volatile computer-readable recording medium according to claim 10,
wherein the third program code causes the computer to, upon detection of a display termination operation on the operation panel while the message screen is being displayed, terminate the display of the message screen and display the operation screen on the operation panel.

12. The non-volatile computer-readable recording medium according to claim 7,
wherein the message data includes target-user attribute information, and
the third program code causes the computer to, upon receipt of the instruction to display the message screen provided by the second program code while the operation screen is not being displayed, immediately display the message screen when the target-user attribute according to the target-user attribute information is a general user, and when the target-user attribute according to the target-user attribute information is a management user, display the message screen upon detection of an end of an operation of the operation panel performed by the management user.

13. A message display control method comprising:
displaying, via an operation panel, a screen and receiving an operation performed by a user;
providing, via an agent unit, upon receipt of message data from a remote maintenance server on a maintenance service provider side, an instruction to display a message screen based on the message data; and
controlling, via a display control unit, the display of a screen of the operation panel and displaying, upon receipt of the instruction to display a message screen from the agent unit while an operation screen is being displayed, the message screen on the operation panel when an end of an operation of the operation panel performed by the user is detected.

14. The message display control method according to claim 13, comprising:
detecting, via a user management unit, a log-in operation and a log-out operation performed on the operation panel by the user, and
the display control unit, upon receipt of the instruction to display the message screen from the agent unit while the operation screen subsequent to the log-in operation is being displayed, displays the message screen on the operation panel when the user management unit detects the log-out operation.

15. The message display control method according to claim 13,
wherein the display control unit, upon receipt of the instruction to display the message screen from the agent unit while the operation screen is being displayed, immediately displays, if there is a notification area in the operation screen, a notification image indicating reception of the message data in the notification area on the operation panel.

16. The message display control method according to claim 15,
wherein the display control unit, upon detection of a specific operation on the operation panel while the notification image is being displayed, displays the message screen in such a manner that the message screen is superimposed on the operation screen.

17. The message display control method according to claim 16,
wherein the display control unit, upon detection of a display termination operation on the operation panel while the message screen is being displayed, terminates the display of the message screen and displays the operation screen on the operation panel.

18. The message display control method according to claim 13,
wherein the message data includes target-user attribute information, and
the display control unit, upon receipt of the instruction to display the message screen from the agent unit while the operation screen is not being displayed, immediately displays the message screen when the target-user attribute according to the target-user attribute information is a general user, and when the target-user attribute according to the target-user attribute information is a management user, displays the message screen upon detection of an end of an operation of the operation panel performed by the management user.
